(19) United States
(12) Patent Application Publication
(10) Pub. No.: US 2006/0280121 A1
(43) Pub. Date: Dec. 14, 2006

(54) Frame-transfer control device, DoS-attack preventing device, and DoS-attack preventing system

(75) Inventor: Kazumine Matoba, Kawasaki (JP)

Correspondence Address: KATTEN MUCHIN ROSENMAN LLP, 575 MADISON AVENUE, NEW YORK, NY, 10022-2585, US

(73) Assignee: FUJITSU LIMITED

(21) Appl. No.: 11/233,750

(22) Filed: Sep. 23, 2005

(30) Foreign Application Priority Data
Jun. 13, 2005 (JP) 2005-172867

(51) Int. Cl. H04J 1/16

(52) U.S. Cl. 370/235

(57) ABSTRACT

A prior information collecting unit transmits in advance a SYN/ACK frame to an address of a client in an external network, and monitors a response to the SYN/ACK frame. If there is no response, the prior information collecting unit determines that the address is a valid attack address. If there is a response with a RST frame, the prior information collecting unit determines that the address is an invalid attack address. An address holding unit stores a responding state of the client. A valid attack identifying unit detects a valid attack frame having a valid attack address as a source address from among frames addressed to the server, based on information stored in the address holding unit. A flow rate limiting unit limits a flow rate at the time of transferring the valid attack frames to the server.

### CROSS-REFERENCE TO RELATED APPLICATIONS

This application is based upon and claims the benefit of priority from the prior Japanese Patent Application No.2005-172867, filed on Jun. 13, 2005, the entire contents of which are incorporated herein by reference.

### BACKGROUND OF THE INVENTION

1. Field of the Invention

The present invention relates to a frame-transfer control device, a denial-of-service (DoS)-attack preventing device, and a DoS attack preventing system for protecting a network connected to a server from illegal accesses such as a DoS attack from an external network.

2. Description of the Related Art

In recent years, in an internal network such as an intranet that is built in a specific area in an enterprise, a firewall is installed at a boundary between the internal network and an external network such as the Internet, thereby protecting a server and clients connected to the internal network from being attacked from the external network. As one of attacks to a server, there is a DoS attack that interrupts the server from providing service to legitimate clients, by making a large amount of connection requests to the server to increase the load on the server. The server means an apparatus that provides services to the clients, and the clients mean apparatuses that receive the services. Both the server and the clients are not only hardware but also software executed by the hardware such as a computer.

FIG. 19 depicts a normal connection procedure according to a transmission control protocol (TCP). In establishing a connection based on the three-way handshake according to the TCP, a client 1 first transmits a synchronize (SYN) frame to a server 2 to request for a connection, as shown in FIG. 19. Upon receiving the SYN frame, the server 2 responds to a synchronize/acknowledge (SYN/ACK) frame to the client 1. In reply to this response of the SYN/ACK, the client 1 further transmits an acknowledge (ACK) frame to the server 2. Accordingly, a connection between the client 1 and the server 2 is established according to the TCP.

The SYN frame that is transmitted to the server at the time of three-way handshake is classified into three types of frames including a non-attack frame, an invalid attack frame, and a valid attack frame. The non-attack frame is a SYN frame that is transmitted from a legitimate client. In this case, the connection is normally established as described above (see FIG. 19).

FIG. 20 depicts a connection procedure according to the TCP when an invalid DoS attack is carried out. The invalid attack frame is a SYN frame that is transmitted from an attacker by assuming an address of a different existing client as a source address. As shown in FIG. 20, when the server 2 receives a SYN frame (under assumed false address of the existing client 1) transmitted from an attacker 3, the server 2 responds to a SYN/ACK frame to the client 1. Because the client 1 receives the SYN/ACK frame from the server 2 even although the client 1 does not actually transmit a SYN frame, the client 1 transmits a reset (RST) frame to the server 2. Accordingly, the connection according to the TCP is disconnected.

FIG. 21 depicts a connection procedure according to the TCP when a valid DoS attack is carried out. The valid attack frame is a SYN frame that is transmitted from an attacker by assuming a dummy address of a non-existing client as a source address. As shown in FIG. 21, when the server 2 receives a SYN frame (that is an assumed false address of a dummy client 4) transmitted from the attacker 3, the server 2 responds with a SYN/ACK frame to the client 4. However, there is no response frame to the server 2 in reply to the SYN/ACK frame. Therefore, the server 2 becomes in a half-open state in which a connection is not established. The server 2 releases a resource such as a memory for the TCP connection, after waiting until a time-out of several tens of seconds.

Therefore, when a large amount of valid attack frames are transmitted and when the number of times of the half-open state increases, the amount of resource for the server 2 to carry out the TCP connection increases. When the secured amount of resource reaches an upper limit value of the server 2, the server 2 cannot secure new resource for non-attack frames. Therefore, connection requests from the legitimate client 1 are disregarded, and the provision of service from the server 2 to the legitimate client is interfered. This DoS attack is called a SYN flooding attack.

As countermeasures based on the firewall against such attack, a method based on statistical information and a method based on collection of information beforehand are available. The method based on statistical information includes a method (a first method) of forcibly disconnecting a TCP connection of the server when the number of the half-open states exceeds a threshold, and a method (a second method) of limiting a flow rate of SYN frames of all traffics. The method based on collection of information beforehand includes a method (a third method) of transferring, with priority, frames that are transmitted from a client of which connection with the server is recently established.

As one of the methods based on statistical information, the following illegal-access monitoring system is known. According to this monitoring system, an analysis terminal is provided at each entrance route from an external network to a backbone network. Each analysis terminal analyzes packets that enter the backbone network from each entrance route, and extracts illegal-access candidates. A managing terminal collects results of analysis from analysis terminals, and detects illegal accesses based on a result of the collection (for example, see Japanese Patent Application Laid-open No. 2004-164107). As one of the methods based on collection of information beforehand, there is the following network management system. According to this system, only a network device having a multi access computer (MAC) address stored in advance in a database is set as a device that can be connected to a predetermined network. Based on identification information of a network device connected to the network, the network management system determines whether this network device can be connected to the network (for example, see Japanese Patent Application Laid-open No. 2004-241831).

However, in the SYN flooding attack, an attacker optionally assumes a false source address. Therefore, it is impossible to discriminate between a valid attack frame and a non-attack frame by simply referring header information of a SYN frame. Because the firewall cannot abandon a valid attack frame by discriminating this frame, the traffics of all users is influenced by traffic of the valid attack traffic. According to the first method, all frames including a valid attack frame are transferred to the server. Therefore, when the number of valid attack frames increases, processing load of a connection and a disconnection of the server becomes high, resulting in a service inability.

According to the second method, flow rates of all frames including non-attack frames and valid attack frames are limited. Therefore, when the number of valid attack frames increases, non-attack frames are abandoned in high probabilities. Consequently, provision of service to legitimate clients is interrupted. According to the third method, the flow rate of non-attack frames from clients that have never accessed the server before is also limited as well as the flow rate of valid attack frames. Accordingly, when the number of valid attack frames increases, provision of service to the clients of the non-attack frames is interrupted.

### SUMMARY OF THE INVENTION

It is an object of the present invention to at least solve the above problems in the conventional technology.

A frame-transfer control device according to one aspect of the present invention is configured to transfer, to a network to which a server is connected, a frame transmitted from a client in an external network. The frame-transfer control device includes a transmitting unit configured to periodically transmit a response request to the client, and to monitor a response to the response request from the client to grasp a responding state of the client; an identifying unit configured to identify whether the frame is any one of a legitimate frame and an illegitimate frame based on the responding state; and a limiting unit configured to transfer the legitimate frame to the server by priority, and to limit transfer of the illegitimate frame.

An attack preventing device according to another aspect of the present invention is configured to protect a network to which a server is connected, from an attack from an external network. The attack preventing device includes a transmitting unit configured to transmit a first frame to at least one client connected to the external network, and to monitor a response to the first frame from the client with a second frame, to grasp a responding state of the client; a first storing unit configured to store the responding state corresponding to an address of the client; an detecting unit configured to detect an offensive frame with which the network is attacked from among at least one frame transmitted from the external network toward the server, based on information stored in the first storing unit; and a limiting unit configured to limit a flow rate of the offensive frame by adjusting a transmission band to transfer the frame to the server.

An attack preventing system according to still another aspect of the present invention is configured to protect a network to which a server is connected, from an attack from an external network. The attack preventing system includes a first processing device configured to be connected to the external network; and a second processing device configured to be connected to the network. The first processing device includes a transmitting unit configured to transmit a first frame to at least one client connected to the external network, and to monitor a response to the first frame from the client with a second frame, to grasp a responding state of the client; a first storing unit configured to store the responding state corresponding to an address of the client; and a transferring unit configured to transfer information stored in the first storing unit to the second processing device. The second processing device includes a second storing unit configured to store transferred information; a detecting unit configured to detect an offensive frame with which the network is attacked from among at least one frame transmitted from the external network toward the server, based on information stored in the second storing unit; and a limiting unit configured to limit a flow rate of the offensive frame by adjusting a transmission band to transfer the frame to the server.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a schematic of a network that is provided with a DoS-attack preventing device according to a first embodiment of the present invention;

FIG. 2 is a block diagram of the DoS-attack preventing device according to the first embodiment;

FIG. 3 is a schematic of an address holding unit;

FIG. 4 is a flowchart of a prior information collection operation according to the first embodiment;

FIG. 5 is a flowchart of a frame transfer operation according to the first embodiment;

FIG. 6 is a block diagram of a DoS-attack preventing device according to a second embodiment of the present invention;

FIG. 7 is a flowchart of a frame transfer operation according to the second embodiment;

FIG. 8 is a block diagram of a DoS-attack preventing device according to a third embodiment of the present invention;

FIG. 9 is a flowchart of a frame transfer operation according to the third embodiment;

FIG. 10 is a block diagram of a DoS-attack preventing device according to a fourth embodiment of the present invention;

FIG. 11 is a flowchart of a session monitoring operation according to the fourth embodiment;

FIG. 12 is a block diagram of a DoS-attack preventing device according to a fifth embodiment of the present invention;

FIG. 13 is a flowchart of a check-time control operation according to the fifth embodiment;

FIG. 14 is a schematic of a network that is provided with a DoS attack preventing system according to a sixth embodiment of the present invention;

FIG. 15 is a block diagram of a pre-processing device of the DoS attack preventing system according to the sixth embodiment;

FIG. 16 is a block diagram of a post-processing device of the DoS attack preventing system according to the sixth embodiment;

FIG. 17 is a flowchart of an operation of the pre-processing device;

FIG. 18 is a flowchart of an operation of the post-processing device;

FIG. 19 depicts a normal connection procedure according to the TCP;

FIG. 20 depicts a connection procedure according to the TCP when an invalid DoS attack is carried out; and

FIG. 21 depicts a connection procedure according to the TCP when a valid DoS attack is carried out.

### DETAILED DESCRIPTION OF THE PREFERRED EMBODIMENTS

Exemplary embodiments of the present invention will be explained below in detail with reference to the accompanying drawings. A frame-transfer control device is used as a DoS-attack preventing device. The frame-transfer control device is also used to control transfer of illegitimate frames that are transmitted by assuming a source address, as well as to prevent a DoS attack. In the following embodiments, like constituent elements are designated with like reference numerals, and redundant explanations are omitted.

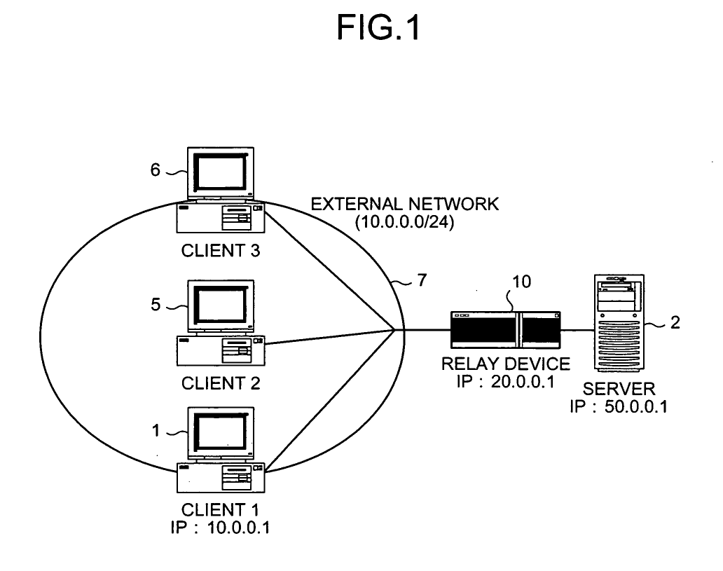

FIG. 1 is a schematic of a network that is provided with a DoS-attack preventing device (frame-transfer control device) according to a first embodiment of the present invention. As shown in FIG. 1, the DoS-attack preventing device is connected as a relay device 10 between the server 2 and an external network 7 that is a target of monitoring a SYN flooding attack. Plural clients 1, 5, and 6 are connected to the external network 7. The server 2 is connected to an internal network (not shown) that is built in a specific area of an enterprise or the like.

For the convenience of explanation, internet protocol (IP) addresses of the first client 1, the DoS-attack preventing device 10, and the server 2 are expressed as [10.0.0.1], [20.0.0.1], and [50.0.0.1] respectively, although there is no particular limit to the addresses. It is assumed that subnets of the clients 1, 5, and 6 that are connected to the external network 7 have addresses within [10.0.0.0/24], that is, from [10.0.0.0] to [10.0.0.255], although there is no particular limit to the addresses. Subnet addresses that are the same as the above are set in the DoS-attack preventing device 10 in advance.

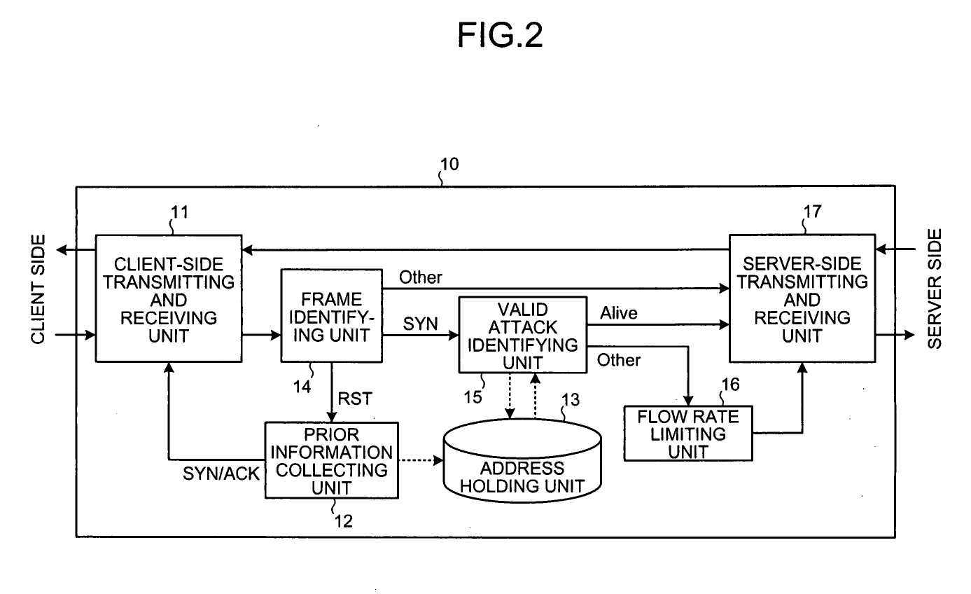

FIG. 2 is a block diagram of the DoS-attack preventing device 10. As shown in FIG. 2, the DoS-attack preventing device 10 includes a client-side transmitting and receiving unit 11, a prior information collecting unit 12, an address holding unit 13, a frame identifying unit 14, a valid attack identifying unit 15, a flow rate limiting unit 16, and a server-side transmitting and receiving unit 17.

The client-side transmitting and receiving unit 11 is connected to the external network 7, and transmits and receives frames to and from the external network 7. For example, when the client-side transmitting and receiving unit 11 receives a frame from a client to the server, the client-side transmitting and receiving unit 11 transmits the frame to the frame identifying unit 14. The client-side transmitting and receiving unit 11 also receives a SYN/ACK frame from the prior information collecting unit 12, and transmits this SYN/ACK frame to the client. The client-side transmitting and receiving unit 11 also receives a frame from the server-side transmitting and receiving unit 17, and transmits this frame to the client.

The prior information collecting unit 12 periodically transmits a SYN/ACK frame to the client via the client-side transmitting and receiving unit 11, and monitors a response with a RST frame from the client. For example, the prior information collecting unit 12 periodically prepares a SYN/ACK frame to all addresses of the subnet [10.0.0.0/24] that is a target of monitoring a SYN flooding attack, and transmits the SYN/ACK frame to the client-side transmitting and receiving unit 11. When the prior information collecting unit 12 receives a RST frame from the frame identifying unit 14 in reply to this SYN/ACK frame, the prior information collecting unit 12 determines that a client that has returned the RST frame is a legitimate client.

The prior information collecting unit 12 sets a value “0” as a valid attack flag for the legitimate client to register in the address holding unit 13 associating with the address of the legitimate client. On the other hand, for an address from which a RST frame is not returned within a predetermined time from transmission of a SYN/ACK frame, the prior information collecting unit 12 sets a value “1” as the valid attack flag for a corresponding client to register in the address holding unit 13 corresponding to an address of the corresponding client.

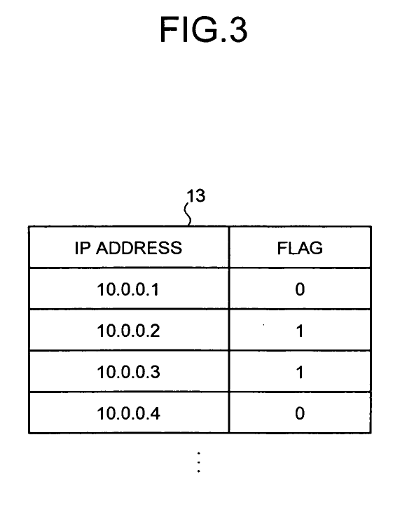

The address holding unit 13 holds each address to be checked and the value (“0” or “1”) of the valid attack flag. FIG. 3 is a schematic of the address holding unit 13. The frame identifying unit 14 identifies header information of a frame received from the client-side transmitting and receiving unit 11, and identifies whether the received frame is a RST frame to the own station (the DoS-attack preventing device 10), a SYN frame to be relayed, or other frame. When the received frame is the RST frame for the own station, the frame identifying unit 14 transmits this frame to the prior information collecting unit 12. When the received frame is a SYN frame, the frame identifying unit 14 transmits this frame to the valid attack identifying unit 15. When the received frame is other frame, the frame identifying unit 14 transmits this frame to the server-side transmitting and receiving unit 17.

The valid attack identifying unit 15 identifies whether a frame to be transferred to the server 2 is a valid attack frame. For example, when the valid attack identifying unit 15 receives a frame from the frame identifying unit 14, the valid attack identifying unit 15 reads a corresponding entry from the address holding unit 13 based on the address of the transmitter of the frame. When the value of the valid attack flag of the read entry is “0”, the valid attack identifying unit 15 transmits the frame to the server-side transmitting and receiving unit 17. On the other hand, when the value of the valid attack flag of the read entry is “1”, the valid attack identifying unit 15 transmits the frame to the flow rate limiting unit 16.

The flow rate limiting unit 16 adjusts a frame transmission band for transferring the valid attack frame to the server, and limits the flow rate to the server. The flow rate limiting unit 16 transmits the frame to the server-side transmitting and receiving unit 17 so that the flow rate of the total SYN frames is within one frame per second, for example, although there is no particular limit to the flow rate.

The server-side transmitting and receiving unit 17 is connected to the internal network at the server side, and transmits and receives frames to and from the internal network. For example, the server-side transmitting and receiving unit 17 receives a frame from the server 2, and transfers this frame to the client-side transmitting and receiving unit 11. Furthermore, the server-side transmitting and receiving unit 17 receives a frame from the frame identifying unit 14, the valid attack identifying unit 15, or the flow rate limiting unit 16, and transfers the received frame to the server.

It is assumed that in the configuration shown in FIG. 1, the client (first client) 1 is a legitimate client, and the client (second client) 5 is not a legitimate client. An operation of the DoS-attack preventing device 10 is classified into the following five cases: when a SYN/ACK frame is transmitted to the first client 1 (case 1); when a SYN/ACK frame is transmitted to an address (for example, [10.0.0.5]) to which a host address is not yet allocated (case 2); when the first client 1 communicates with the server 2 (case 3); when the second client 5 attacks the network by assuming a false address [10.0.0.1] of the first client 1 (case 4); and when the second client 5 attacks the network by assuming a false address (for example, [10.0.0.5]) to which a host address is not yet allocated (case 5).

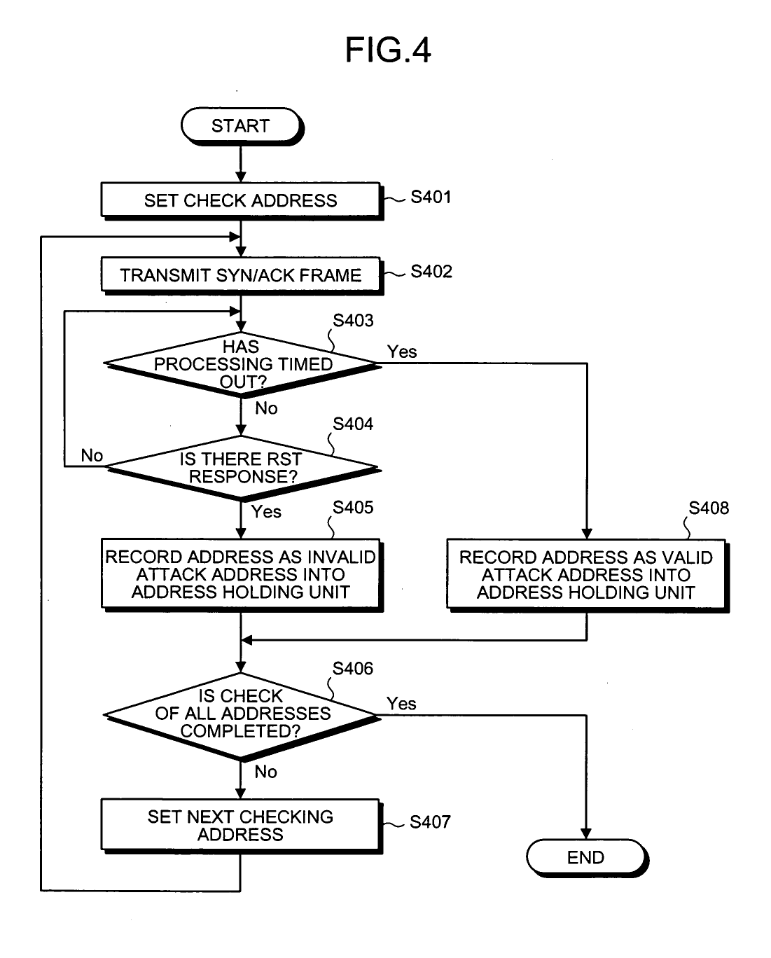

FIG. 4 is a flowchart of the prior information collection operation according to the first embodiment. (1) The prior information collecting unit 12 recognizes that a predetermined time (for example, 15 minutes) has passed since the last collection processing, and notifies the client-side transmitting and receiving unit 11 that a SYN/ACK frame is to be transmitted to the address [10.0.0.1] of the first client 1. Simultaneously with the transmission of the SYN/ACK frame, the prior information collecting unit 12 starts a timer to measure time for waiting for a response to the transmitted SYN/ACK frame, thereby starting the collection of information.

(2) The client-side transmitting and receiving unit 11 sets the own (the DoS-attack preventing device 10) address [20.0.0.] as a source address that becomes the check address (step S401), and transmits a SYN/ACK frame to the client-side network (step S402).

(3) The first client 1 receives the SYN/ACK frame. However, because a SYN frame is not transmitted before the SYN/ACK frame, the first client 1 transmits a RST frame to the [20.0.0.1] of the DoS-attack preventing device 10 based on the TCP. The RST frame usually reaches the DoS-attack preventing device 10 before the timer times out.

(4) At step S403, it is determined whether the processing at step S402 times out. Presence/absence of a RST response is determined at step S404. The client-side transmitting and receiving unit 11 receives the RST frame that is a response from the first client 1 (“YES” at step S404) before time is out (“NO” at step S403), and transmits this RST frame to the frame identifying unit 14. (5) Because the received frame is the RST frame and the destination address is the [20.0.0.1] of the own station, the frame identifying unit 14 transmits this frame to the prior information collecting unit 12. (6) The prior information collecting unit 12 records the source address [10.0.0.1] as the invalid attack address into the address holding unit 13 (step S405), and records an entry having the value “0” as the valid attack flag. Accordingly, the address [10.0.0.1] is registered as the invalid attack address into the DoS-attack preventing device 10. The prior information collecting unit 12 stops the timer that is started at the time of starting the collection of information.

The operations (1) to (6) correspond to case 1. At step S406, when the check of all addresses within a specific subnet assigned in advance has not yet been finished, that is, when the check of all addresses has not yet been completed (“NO” at step S406), the next address is set in a similar manner (step S407), thereby repeating the check. For example, following the check of the address [10.0.0.1], the addresses [10.0.0.2], [10.0.0.3] are sequentially assigned as destination addresses, and are sequentially checked. During the repeated check, the operation corresponds to case 2 at some stage.

(7) For example, the prior information collecting unit 12 notifies the client-side transmitting and receiving unit 11 that a SYN/ACK frame is to be transmitted to the address [10.0.0.5], following the check of the address [10.0.0.4]. The prior information collecting unit 12 sets the next address (step S407). The prior information collecting unit 12 then starts the timer. It is assumed that a terminal of the address [10.0.0.5] does not exist. (8) The client-side transmitting and receiving unit 11 sets the source address [20.0.0.1], and transmits a SYN/ACK frame to the client-side network (step S402). (9) Because a terminal having the address [10.0.0.5] is not connected to the client-side network, the SYN/ACK frame transmitted to the address [10.0.0.5] is abandoned.

(10) On the other hand, because a RST frame is not returned to the DoS-attack preventing device 10, the prior information collecting unit 12 recognizes at step S403 a time-out state, that is, a state in which the timer has passed a predetermined time (for example, one second) (“YES” at step S403). The address holding unit 13 records the set address at this time as a valid attack address (step S408), by recording the entry having the address [10.0.0.5] and the valid attack flag “1” of this address. Accordingly, the address [10.0.0.5] is registered as the valid attack address into the DoS-attack preventing device 10. The prior information collecting unit 12 stops the timer that is started at the address setting time at step S407. When the check of all addresses in a specific subnet is completed, the prior information collection operation is completed, and valid attack flags are registered for all addresses. The above processing is repeated until the recording for all addresses is completed (“YES” at step S406), a series of processing is finished.

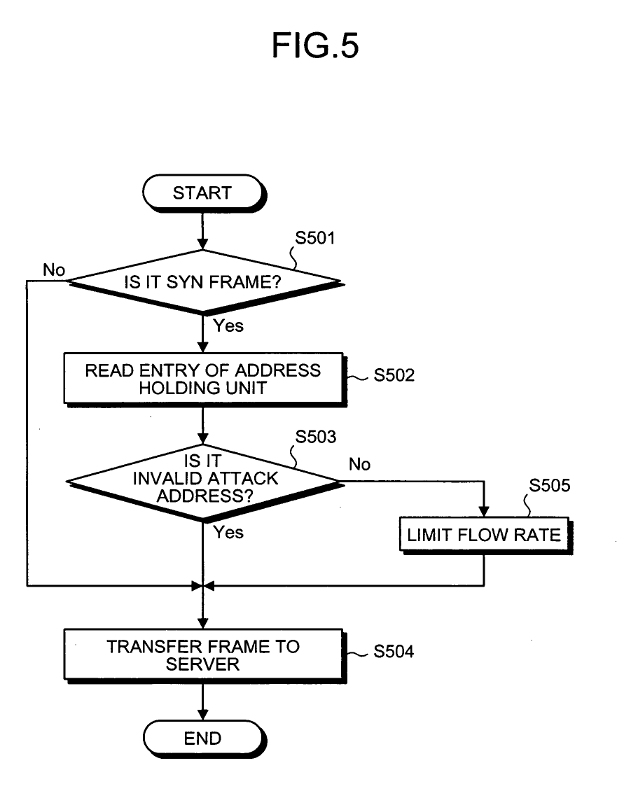

FIG. 5 is a flowchart of the frame transfer operation according to the first embodiment. Case 2 is explained first. (11) The first client 1 sets the own address [10.0.0.1] as a source address, and transmits a TCP SYN frame to the address [50.0.0.1] of the server 2. (12) The client-side transmitting and receiving unit 11 receives the frame transmitted from the first client 1, and transmits this frame to the frame identifying unit 14.

(13) As shown in FIG. 5, the frame identifying unit 14 receives the frame from the client-side transmitting and receiving unit 11, and determines whether this frame is a SYN frame (step S501). When the received frame is a SYN frame to the address [50.0.0.1] of other station (“YES” at step S501), the frame identifying unit 14 transmits this frame to the valid attack identifying unit 15. (14) The valid attack identifying unit 15 reads a corresponding entry of the received frame from the address holding unit 13 based on the source address [10.0.0.1] of the received frame (step S502). The valid attack identifying unit 15 determines whether the address that is read at step S502 is an invalid attack address (step S503). When the address is an invalid attack address (“YES” at step S503), the valid attack flag of the corresponding entry is “0”. Therefore, the valid attack identifying unit 15 transfers this frame to the server-side transmitting and receiving unit 17 (step S504). (15) The server-side transmitting and receiving unit 17 receives the transferred frame, and transmits the received frame to the server-side network, thereby ending a series of processing.

(16) The server 2 receives the SYN frame transferred from the DoS-attack preventing device 10, and transmits a SYN/ACK frame to the address [10.0.0.1] of the first client 1 in reply to the SYN. (17) The server-side transmitting and receiving unit 17 receives the SYN/ACK frame transmitted from the server 2 to the address [10.0.0.1], and transmits this SYN/ACK frame to the client-side transmitting and receiving unit 11. (18) The client-side transmitting and receiving unit 11 transmits the received SYN/ACK frame to the client-side network. (19) The first client 1 receives the SYN/ACK frame, and transmits an ACK frame to the address [50.0.0.1] of the server 2 in reply to the SYN/ACK frame.

(20) The client-side transmitting and receiving unit 11 receives the ACK frame transmitted from the first client 1, and transmits the received ACK frame to the frame identifying unit 14. (21) The frame identifying unit 14 makes determination at step S501 on the received frame. Because the frame received from the client-side transmitting and receiving unit 11 is to the address [50.0.0.1] of other station and because the frame is not a SYN frame (“NO” at step S501), the frame identifying unit 14 transmits this received ACK frame to the server-side transmitting and receiving unit 17. (22) The server-side transmitting and receiving unit 17 transmits the received ACK frame to the server-side network (step S504), and ends a series of processing.

(23) The server 2 receives the ACK frame transferred from the DoS-attack preventing device 10, and establishes a TCP connection with the first client 1. Thereafter, the operation carried out to the frame transmitted from the client to the server 2 is similar to the operations from (19) to (23). The operation carried out to the frame transmitted from the server 2 to the client is similar to operations from (16) to (18). Therefore, redundant explanations are omitted.

(24) In case 4, the second client 5 sets the address [10.0.0.1] of the first client 1 as a source address assuming a false address. The second client 5 transmits a TCP SYN frame to the address [50.0.0.1] of the server 2. (25) The client-side transmitting and receiving unit 11 receives this SYN frame, and transmits this frame to the frame identifying unit 14. (26) The frame identifying unit 14 determines about the frame at step S501. Because the received frame is the SYN frame that is to the address [50.0.0.1] of other station (“YES” at step S501), the frame identifying unit 14 transmits this frame to the valid attack identifying unit 15.

(27) The valid attack identifying unit 15 reads the entry of the address [10.0.0.1] from the address holding unit 13 (step S502), and makes determination at step S503 on the frame. Because the valid attack flag of the entry is “0”, the valid attack identifying unit 15 determines that the address is an invalid attack address (“YES” at step S503), and transfers this frame to the server-side transmitting and receiving unit 17, thereby ending a series of processing. (28) The server-side transmitting and receiving unit 17 transmits the frame to the server-side network. (29) The server 2 receives the transferred SYN frame, and transmits a SYN/ACK frame to the address [10.0.0.1] of the first client 1 in response to the received SYN frame.

(30) The server-side transmitting and receiving unit 17 receives the SYN/ACK frame, and transmits this frame to the client-side transmitting and receiving unit 11. (31) The client-side transmitting and receiving unit 11 transmits the received SYN/ACK frame to the client-side network. (32) The first client 1 receives the transmitted SYN/ACK frame. However, because a SYN frame is not transmitted before this SYN/ACK frame, the first client 1 transmits a RST frame to the address [50.0.0.1] of the server 2.

(33) The client-side transmitting and receiving unit 11 receives the RST frame, and transmits this RST frame to the frame identifying unit 14. (34) The frame identifying unit 14 makes the determination at step S501 on the frame. Because the frame received from the client-side transmitting and receiving unit 11 is to the address [50.0.0.1] of other station and because the frame is not a SYN frame (“NO” at step S501), the frame identifying unit 14 transfers this received RST frame to the server-side transmitting and receiving unit 17 (step S504), and ends a series of processing. (35) The server-side transmitting and receiving unit 17 transmits the RST frame to the server-side network. (36) The server 2 receives the RST frame from the first client 1, and confirms that the TCP connection with the first client 1 is disconnected.

(37) In case 5, the second client 5 sets the address [10.0.0.5] as a source address, and transmits a TCP SYN frame to the address [50.0.0.1] of the server 2. As explained in case 2, a client having the address [10.0.0.5] does not exist. In other words, the second client 5 assumes a false address. (38) The client-side transmitting and receiving unit 11 receives this SYN frame, and transmits this frame to the frame identifying unit 14. (39) The frame identifying unit 14 makes the determination at step S501 on the frame. Because the received frame is the SYN frame that is to the address [50.0.0.1] of other station (“YES” at step S501), the frame identifying unit 14 transmits this frame to the valid attack identifying unit 15.

(40) The valid attack identifying unit 15 reads the entry of the address [10.0.0.5] from the address holding unit 13 (step S502), and determines about the frame at step S13. Because the valid attack flag of the entry is “1”, the valid attack identifying unit 15 determines that the address is not an invalid attack address (“NO” at step S503), and transmits this frame to the flow rate limiting unit 16. (41) The flow rate limiting unit 16 puts the received frame together with other SYN frames, and transmits frames to the server-side transmitting and receiving unit 17 at a rate of one frame per second, for example, thereby carrying out a flow rate limit processing (step S505). (42) The server-side transmitting and receiving unit 17 executes the processing at step S504, transmits the received frame to the server-side network, thereby ending a series of processing.

(43) The server 2 receives the SYN frame transferred from the DoS attack control device 10, and transmits a SYN/ACK frame to a terminal of the address [10.0.0.5]. (44) Because a terminal of the address [10.0.0.5] does not exist, the relay device in the network abandons the SYN/ACK frame that is transmitted to the address [10.0.0.5].

(45) The server 2 does not receive an ACK frame from a terminal having the address [10.0.0.5]. Therefore, the server 2 releases the terminal that assumes the false address [10.0.0.5], that is the resource of the TCP connection with the second client 5 as the attacker. According to the first embodiment, only a valid attack frame passes through the flow rate limiting unit 16 in cases 3 to 5. Therefore, the transfer amount of SYN frames can be limited. Consequently, even when a SYN flooding attack is carried out, service for legitimate clients is not interrupted. As a flow rate limiting algorithm, any statistical method can be used.

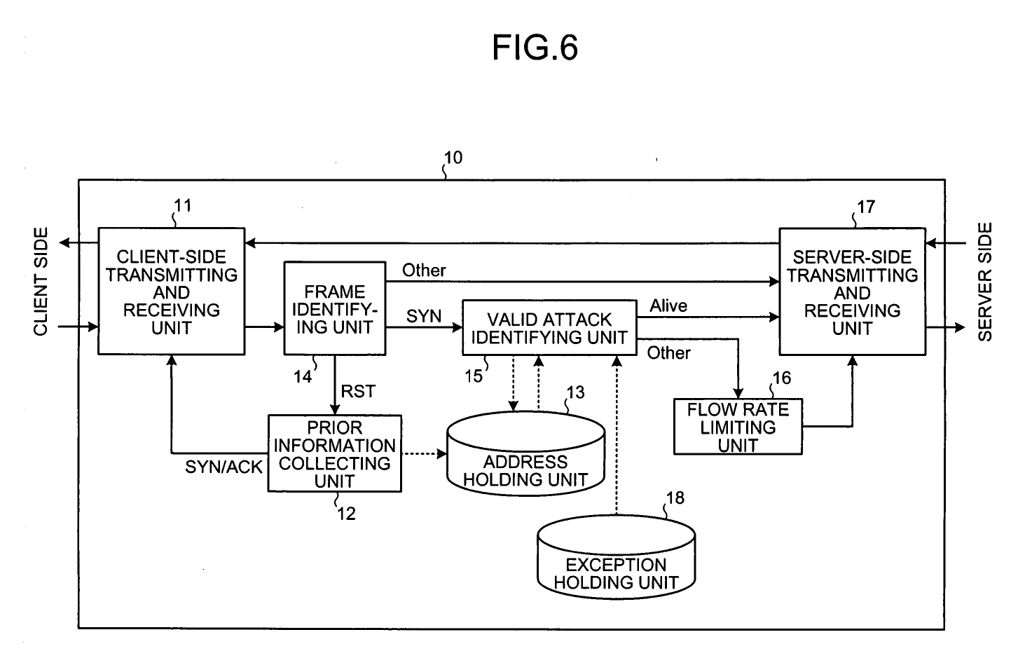

FIG. 6 is a block diagram of a DoS-attack preventing device according to a second embodiment of the present invention. As shown in FIG. 6, the DoS-attack preventing device according to the second embodiment includes an exception holding unit 18 in addition to other functions in the DoS-attack preventing device 10 according to the first embodiment. An address of a legitimate client that is identified as a non-attacker is recorded in advance in the exception holding unit 18.

Upon receiving a frame from the frame identifying unit 14, the valid attack identifying unit 15 searches the exception holding unit 18 for a source address of the frame 8. When the address is registered in the exception holding unit 18, the valid attack identifying unit 15 transmits this frame to the server-side transmitting and receiving unit 17. On the other hand, when the address is not registered in the exception holding unit 18, the valid attack identifying unit 15 reads the entry of the address from the address holding unit 13.

For example, when it is clear, in advance, that the first client 1 is a legitimate client and when communication of the first client is to be excluded from communications of which flow rate is limited, a detailed operation is explained below. A network manager registers the address [10.0.0.1] of the first client as the entry of the exception holding unit 18 in advance. The operation in the second embodiment different from that in the first embodiment is the frame transfer from the server 2 in (14) of case 3.

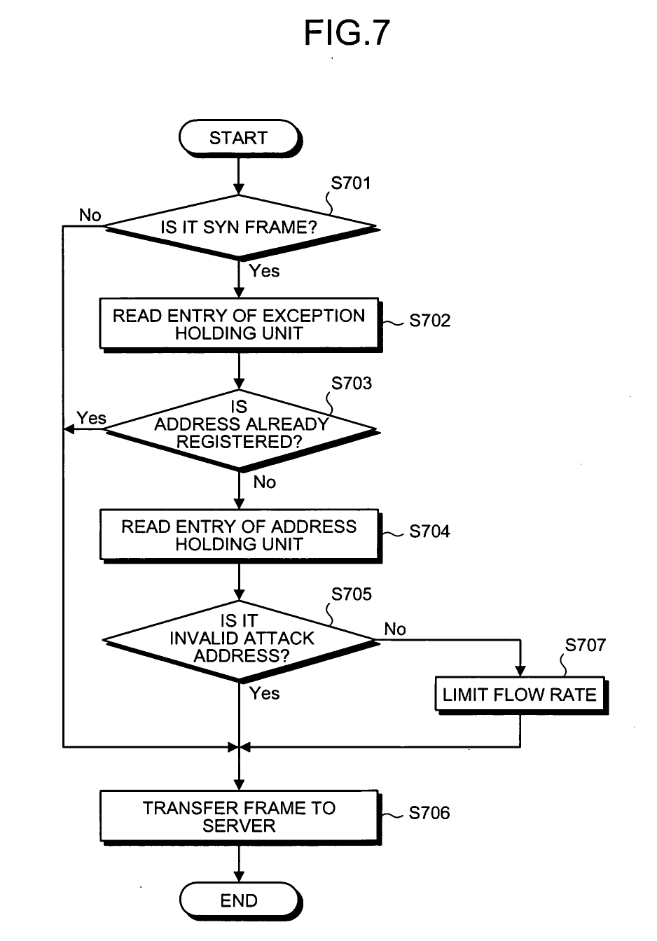

FIG. 7 is a flowchart of the frame transfer operation according to the second embodiment. As shown in FIG. 7, the frame identifying unit 14 receives the frame from the client-side transmitting and receiving unit 11, and determines whether this frame is a SYN frame (step S701). When the received frame is a SYN frame to the address [50.0.0.1] of other station (“YES” at step S701), the frame identifying unit 14 transmits this frame to the valid attack identifying unit 15. The valid attack identifying unit 15 reads a corresponding entry of the received frame from the exception holding unit 18 based on the source address [10.0.0.1] of the frame received from the frame identifying unit 14 (step S702), and searches the exception holding unit 18. Next, the valid attack identifying unit 15 determines whether the address that is read at step S702 is a registered address (step S703). The entry corresponding to the exception holding unit 18 is registered as the address (“YES” at step S703). Therefore, the valid attack identifying unit 15 transmits this frame to the server-side transmitting and receiving unit 17. The server-side transmitting and receiving unit 17 transmits the received frame to the server-side network (step S706), thereby ending a series of processing.

At step S703, when the source address is [10.0.0.2] or [10.0.0.5], that is, the address other than the address of the legitimate client identified in advance (“NO” at step S703), a corresponding entry is not registered in the exception holding unit 18. Therefore, the valid attack identifying unit 15 reads the entry of the address from the address holding unit 13 (step S704), and identifies whether the frame is a valid attack frame (step S705). The processing at step S705 afterward is similar to the processing in the first embodiment shown in FIG. 5, and therefore, redundant explanations are omitted.

According to the second embodiment, the operation other than that of (14) of case 3 is the same as the operation in the first embodiment, and therefore, redundant explanations are omitted. According to the second embodiment, when the address of a specific client, such as the client of which network manager is always activated, is registered in the exception holding unit 18, a frame from the specific client can be always relayed by priority.

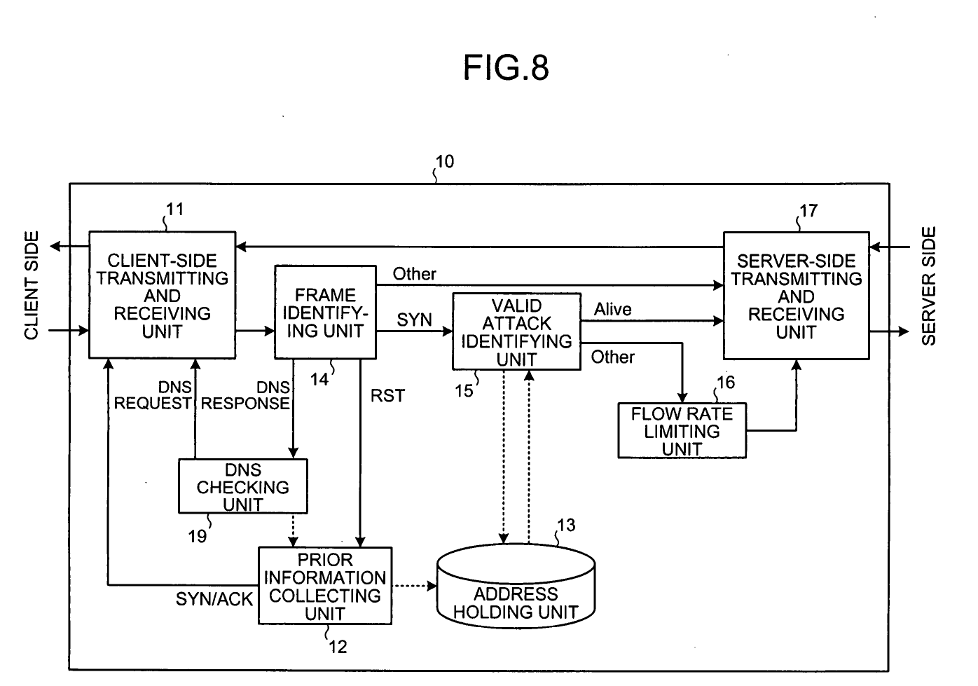

FIG. 8 is a block configuration diagram of a DoS-attack preventing device according to a third embodiment of the present invention. As shown in FIG. 8, the DoS-attack preventing device according to the third embodiment includes a domain-name-system (DNS) checking unit 19 in addition to functions in the DoS-attack preventing device 10 according to the first embodiment. Based on a DNS client function, the DNS checking unit 19 enquires a DNS server at the outside of the device about a host address of each address of an external network such as a specific subnet. In this way, the DNS checking unit 19 checks the address of a terminal already registered in the DNS. The DNS checking unit 19 notifies the prior information collecting unit 12 of an address registered in the DNS out of all addresses in the subnet. The DNS checking unit 19 can obtain a list of host addresses based on a secondary server function of the DNS.

Based on the addition of the DNS checking unit 19, the collection operation of the prior information collecting unit 12 is changed to a collection of a response state of only the address notified from the DNS checking unit 19. Therefore, the prior information collecting unit 12 periodically transmits a SYN/ACK frame to the address of which the host address can be obtained from the DNS checking unit 19 out of the checked subnet addresses [10.0.0.0/24], and monitors a response of a RST frame in reply to the SYN/ACK frame, in as similar manner as the first embodiment. When there is a response with a RST frame, the prior information collecting unit 12 sets “0” to the value of the valid attack flag of the destination address, and registers the value into the address holding unit 13.

When a certain time passes without receiving a RST frame after the transmission of the SYN/ACK frame, the prior information collecting unit 12 sets “1” to the value of the valid attack flag of the destination address, and registers the value into the address holding unit 13. For the address of the host address cannot be obtained by the DNS checking unit 19, that is, the address not registered in the DNS, the prior information collecting unit 12 sets the value “1” to the valid attack flag of the destination address, and registers the value into the address holding unit 13. Furthermore, the frame identifying unit 14 transmits a frame received from the client-side transmitting and receiving unit 11 to the DNS checking unit 19 when this frame is a DNS response frame addressed to the own station.

The operation of periodically checking a host address registered in the DNS is explained next. It is assumed that the address of the external DNS server is [20.0.0.2] and that the list of addresses of the subnet [10.0.0.0/24] is obtained via the DNS server. The DNS server can be installed at any position within a range in which an enquiry message from the DoS-attack preventing device 10 reaches the DNS server.

The operation to be carried out when an address is registered in the DNS is explained first. (46) The DNS checking unit 19 transmits to the client-side transmitting and receiving unit 11 a DNS reverse request frame of the address [10.0.0.1] to the address [20.0.0.2] of the external DNS server. (47) The client-side transmitting and receiving unit 11 transmits this request frame to the client-side network. (48) The external DNS server receives this request frame, and transmits a host address name of the address [10.0.0.1] to the address [20.0.0.1] of the DoS-attack preventing device 10. (49) The client-side transmitting and receiving unit 11 receives the frame transmitted from the DNS server, and transmits this frame to the frame identifying unit 14.

(50) Because the received frame is a DNS response frame to the address [20.0.0.1] of the own station, the frame identifying unit 14 transmits this frame to the DNS checking unit 19. (51) Because the host address name of the DNS response frame has become clear, the DNS checking unit 19 notifies the prior information collecting unit 12 that the checking of the name of the address [10.0.0.1] has succeeded. (52) The prior information collecting unit 12 registers an entry containing the address [10.0.0.1] and a valid attack flag “0” to the address, into the address holding unit 13.

On the other hand, when an address is not registered in the DNS, the following operation is carried out. (53) The DNS checking unit 19 transmits to the client-side transmitting and receiving unit 11 a DNS reverse request frame of the address [10.0.0.5] to the address [20.0.0.2] of the external DNS server. (54) The client-side transmitting and receiving unit 11 transmits this request frame to the client-side network. (55) The external DNS server receives this request frame, and notifies the address [20.0.0.1] of the DoS-attack preventing device 10 that a host address of the address [10.0.0.5] does not exist. (56) The client-side transmitting and receiving unit 11 receives the frame transmitted from the DNS server, and transmits this frame to the frame identifying unit 14.

(57) Because the received frame is a DNS response frame to the address [20.0.0.1] of the own station, the frame identifying unit 14 transmits this frame to the DNS checking unit 19. (58) Because the host address name of the DNS response frame has not become clear, the DNS checking unit 19 notifies the prior information collecting unit 12 that the checking of the name of the address [10.0.0.5] has not been succeeded. (59) The prior information collecting unit 12 registers an entry containing the address [10.0.0.5] and a valid attack flag “1” to the address, into the address holding unit 13.

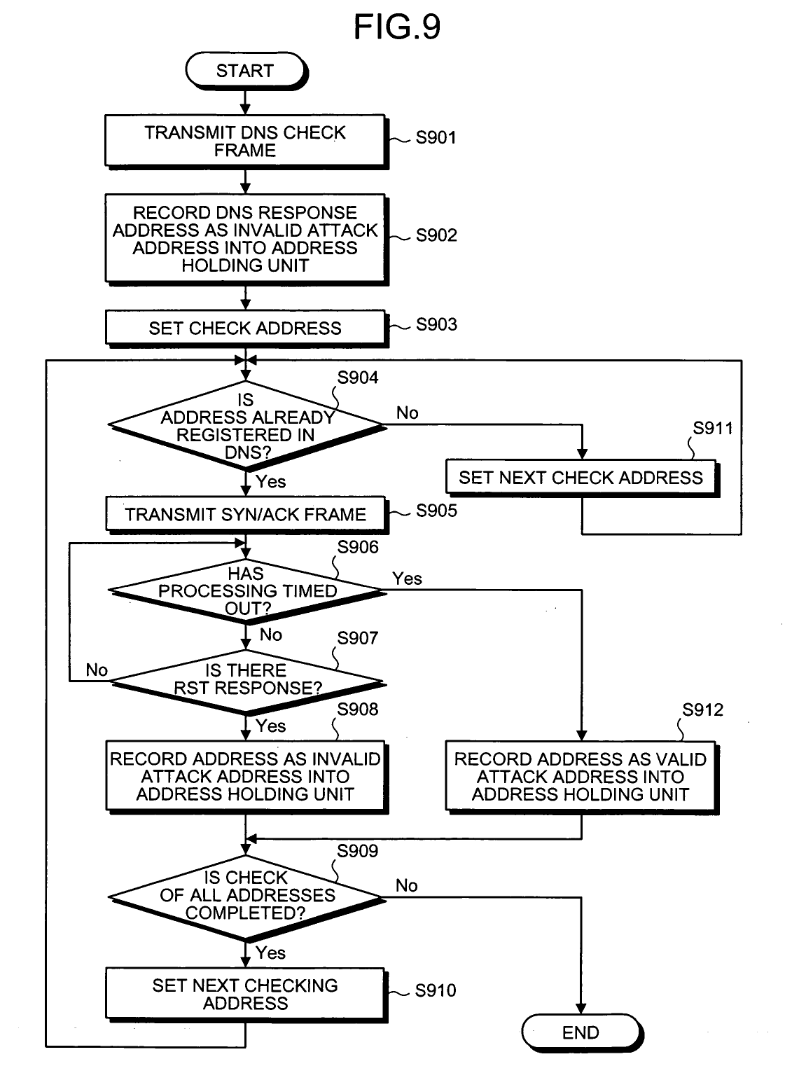

FIG. 9 is a flowchart of the prior information collection operation according to the third embodiment. As shown in FIG. 9, in order to carry out a DNS checking in the operations (46) to (59), a DNS check frame is transmitted (step S901), and a DNS response address is recorded as an invalid attack address in the address holding unit 13 (step S902). Thereafter, a prior information collection operation similar to that of the first embodiment is carried out to all addresses within a specific subnet specified in advance (step S903 to step S912). After the processing at step S903, at the time of transmitting a SYN/ACK frame to each address, it is confirmed whether a destination address of the SYN/ACK frame is already registered in the DNS, before transmitting the SYN/ACK frame (step S904).

When the destination address of the SYN/ACK frame is already registered in the DNS (“YES” at step S904), the SYN/ACK frame is transmitted to this address (step S905). When the destination address of the SYN/ACK frame is not registered in the DNS (“NO” at step S904), the SYN/ACK frame is not transmitted to this address, and a transmission address of the SYN/ACK frame is set to the next check address (step S911). In other words, only when the transmission address of the SYN/ACK frame is registered in the DNS, a prior check according to the transmission of the SYN/ACK frame is carried out. Regarding cases 3 to 5, the operations are similar to those in the first embodiment, and therefore, redundant explanations are omitted.

According to the third embodiment, it is sufficient that the prior information collecting unit 12 carries out a prior checking of only a specific address registered in the DNS in the subnet. Therefore, the number of check processing frames that the prior information collecting unit 12 transmits or receives can be decreased. Consequently, the processing load of the prior information collection can be decreased. In general, the frequency of updating the DNS information is once for a few days to a few months. Therefore, the interval of checking by the DNS checking unit 19 is sufficiently longer than the interval (for example, a few minutes) of information collection by the prior information collecting unit 12. Accordingly, an amount of the processing load on the DNS checking unit 19 is maintained to sufficiently low not to cause a problem.

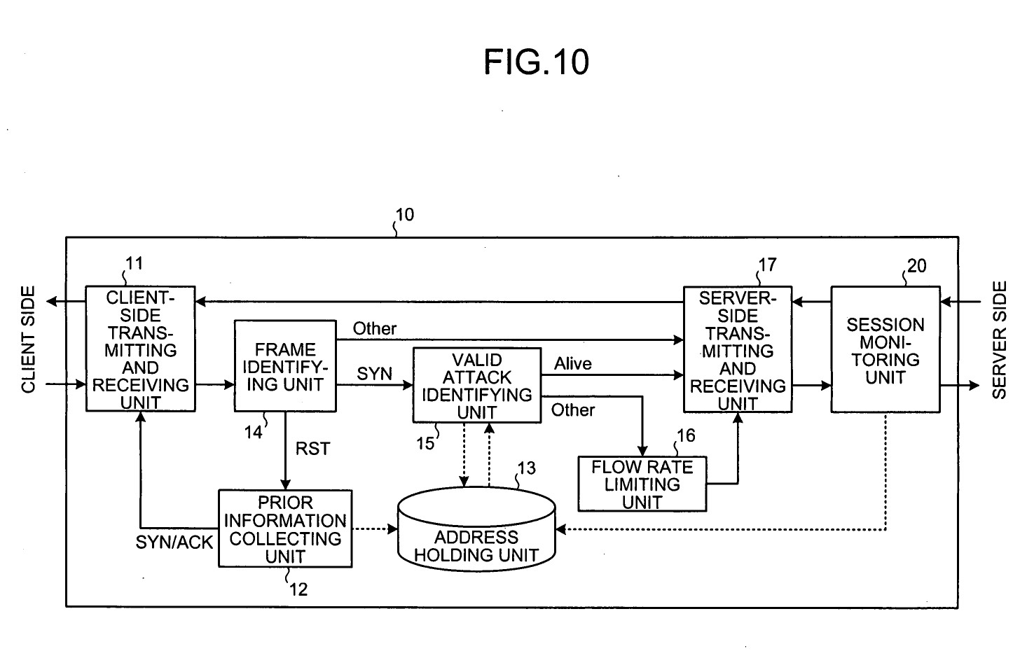

FIG. 10 is a block diagram of a DoS-attack preventing device according to a fourth embodiment of the present invention. As shown in FIG. 10, the DoS-attack preventing device according to the fourth embodiment includes a session monitoring unit 20 in addition to functions in the DoS-attack preventing device 10 according to the first embodiment. The session monitoring unit 20 confirms a flag of a TCP header of a communication frame exchanged between the server 2 and the client. When three frames including a SYN frame, a SYN/ACK frame, and an ACK frame pass, the session monitoring unit 20 sets the value “0” to the invalid attack flag of the address of the client, and registers this value in the address holding unit 13.

The session monitoring operation when the first client 1 normally communicates with the server 2 is explained. It is assumed that the first client is in a state in which power is just turned on, and that the value “1” is set to the valid attack flag of the first client 1, and this is registered into the address holding unit 13. Operations other than the session monitoring operation are similar to those in the first embodiment. Therefore, redundant explanations are omitted.

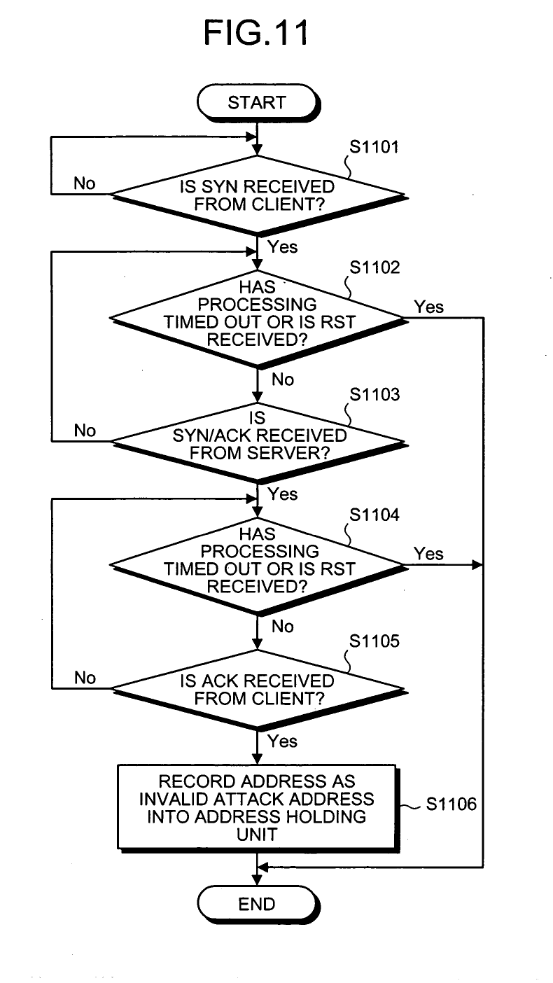

FIG. 11 is a flowchart of the session monitoring operation according to the fourth embodiment. (60) The first client 1 sets the address [10.0.0.1] as a source address, sets 5000 and 80 as a source port number and a destination port number respectively, and transmits a TCP SYN frame to the address [50.0.0.1] of the server 2. (61) The session monitoring unit 20 confirms the SYN frame transmitted from the first client 1 (step S1101), holds the client address [10.0.0.1], the server address [50.0.0.1], the client port number 5000, and the server port number 80, and holds a state that the SYN frame has been transmitted, as connection information.

(62) The server 2 determines whether the SYN frame is received from the client 1 (step S1101). After waiting for the reception of the SYN frame transmitted from the first client 1, the server 2 confirms the reception of the SYN frame (“YES” at step S1101). The server 2 sets [50.0.0.1], [10.0.0.1], 80, and 5000 to the source address, the destination address, the source port number, and the destination port number respectively, and transmits a SYN/ACK frame. (63) The session monitoring unit 20 determines whether the SYN/ACK frame is received from the server 2 (step S1103). After waiting for a reception with the SYN/ACK frame transmitted from the server 2, the session monitoring unit 20 confirms the reception of the SYN/ACK frame (step S1103). The session monitoring unit 20 holds connection information that the transmission state of the SYN frame recorded in the operation (61) has changed to a state of transmitting a SYN/ACK frame.

(64) The first client 1 receives the SYN/ACK frame transmitted from the server 2, sets [10.0.0.1], [50.0.0.1], 5000, and 80 to the source address, the destination address, the source port number, and the destination port number respectively, and transmits an ACK frame. (65) The session monitoring unit 20 determines whether the ACK frame is received from the first client 1 (step S1105). The session monitoring unit 20 confirms a reception of the ACK frame transmitted from the first client 1 (“YES” at step S1105). The session monitoring unit 20 recognizes that the preparation of the connection information recorded in the operation (61) is completed, and records an invalid attack address into the address holding unit 13 (step S1106), by setting the value “0” to the valid attack flag of the client address [10.0.0.1] that is registered in the address holding unit 13, thereby ending a series of processing.

At step S1101, when a RST frame is confirmed in place of a SYN/ACK frame after the first client 1 transmits a SYN frame, or after the transmission of the SYN frame, a time-out is confirmed or a reception of the RST frame is confirmed (step S1102). In case of a time-out, that is, when a certain time has passed, or when a RST frame is received (“YES” at step S1102), the session monitoring operation ends. After the processing at step S1103, it is also confirmed whether a RST frame is received after the server 2 transmits a SYN/ACK frame or whether a certain time has passed (time-out) (step S1104). When the RS frame is confirmed or when a certain time has passed (“YES” at step S1104), the session monitoring operation ends. According to the fourth embodiment, a frame from a client that has normally communicated with the server 2 can be extracted from the flow rate limited frames, and can be relayed by priority.

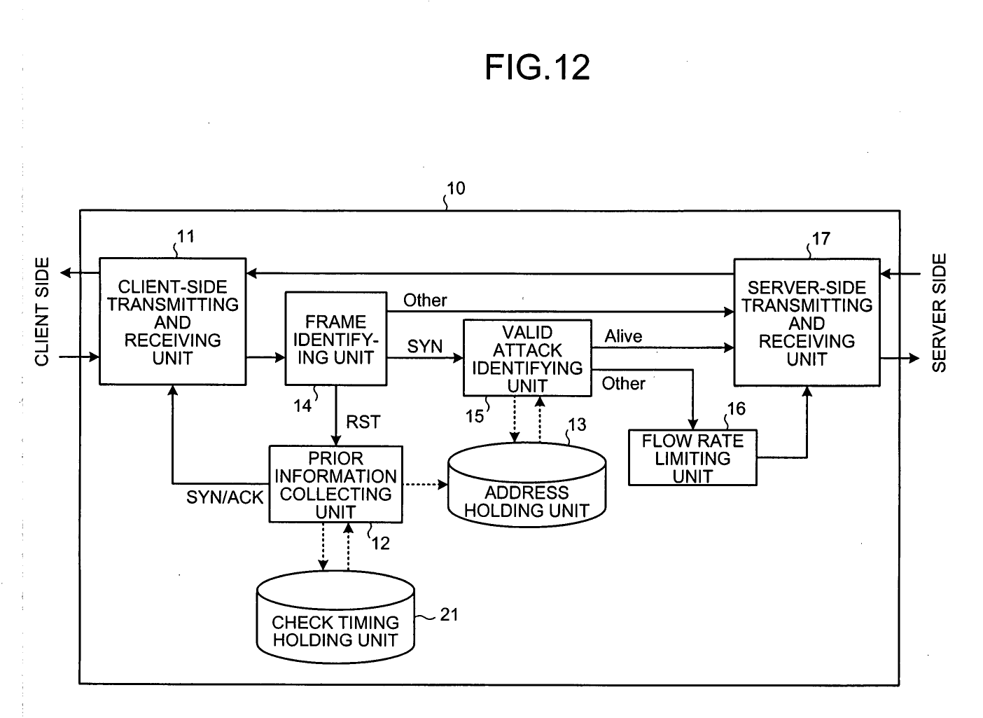

FIG. 12 is a block diagram of a DoS-attack preventing device according to a fifth embodiment of the present invention. As shown in FIG. 12, the DoS-attack preventing device according to the fifth embodiment includes a check timing holding unit 21 in addition to functions in the DoS-attack preventing device 10 according to the first embodiment. The check timing holding unit 21 holds information on a time period (check time) during which the prior information collecting unit 12 carries out a checking. The network manager or the like sets a start time and an end time of checking to the check timing holding unit 21.

When a start time comes, the check timing holding unit 21 notifies the prior information collecting unit 12 that the start time has come, and when an end time comes, the check timing holding unit 21 notifies the prior information collecting unit 12 that the end time has come. When the prior information collecting unit 12 receives the notification of the start time from the check timing holding unit 21, the prior information collecting unit 12 starts a periodical transmission of a SYN/ACK frame as explained in the first embodiment. When the prior information collecting unit 12 receives the notification of the end time from the check timing holding unit 21, the prior information collecting unit 12 ends the transmission of a SYN/ACK frame.

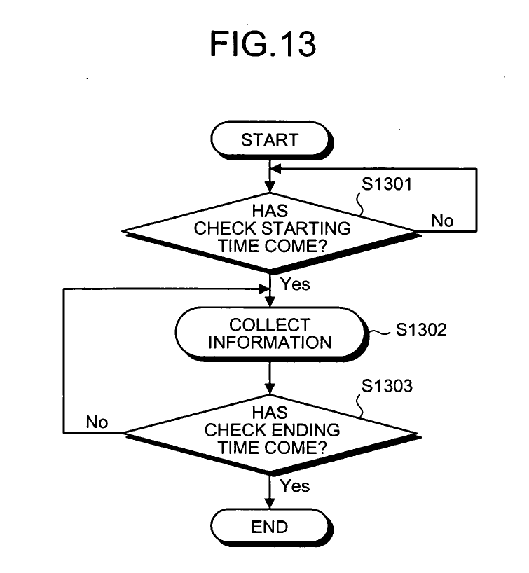

FIG. 13 is a flowchart of a check-time control operation according to the fifth embodiment. The operation carried out is explained with an example when a check time is set to a period from 8:00 a.m. to 5:00 p.m. As shown in FIG. 13, (66) at 8:00 a.m., the check timing holding unit 21 determines whether a start time has come (step S1301). After waiting for the start time, when the start time has come (“YES” at step S1301), the check timing holding unit 21 notifies the prior information collecting unit 12 that the start time has come. (67) The prior information collecting unit 12 receives the notification of the check starting at step S1301, and executes the prior information collection operation of case 1 and case 2 in the first embodiment (step S1302). (68) At 5:00 p.m., the check timing holding unit 21 determines whether an end time has come (step S1303). After waiting for the end time, when the end time has come (“YES” at step S1303), the check timing holding unit 21 notifies the prior information collecting unit 12 that the end time has come (step S1303), thereby ending a series of processing. Accordingly, (69) the prior information collecting unit 12 stops the prior information collection operation.

According to the fifth embodiment, the prior information collecting unit 12 can collect information during the period from 8:00 a.m. to 5:00 p.m., for example. When the network between the client and the DoS-attack preventing device 19 is to be interrupted due to the maintenance work or the like, information before interrupting the network can be handed over after the network returns.

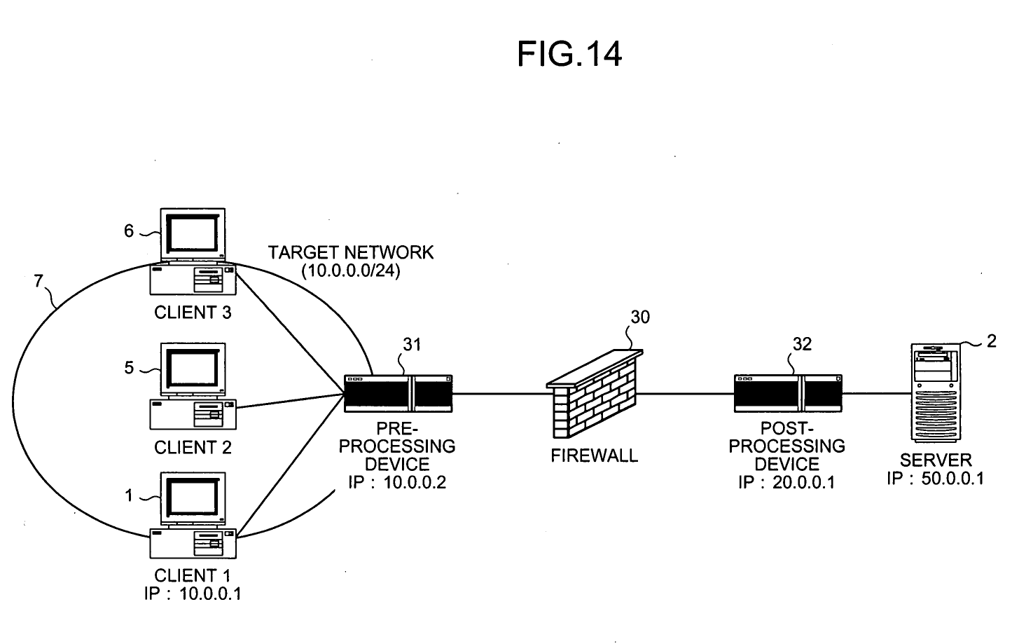

FIG. 14 is a schematic of a network that is provided with a DoS-attack preventing device according to a sixth embodiment of the present invention. As shown in FIG. 14, in the DoS attack preventing system according to the sixth embodiment, the DoS-attack preventing device 10 includes a pre-processing device 31 having a function of collecting prior information, and a post-processing device 32 having a function of identifying a valid attack frame and limiting the flow rate. The pre-processing device 31 is connected to the external network 7, and the post-processing device 32 is connected to the server 2. With this arrangement, a firewall 30 is installed at a boundary between the client-side external network 7 and the server-side internal network. Even when the server cannot directly access the client, prior information collection can be carried out.

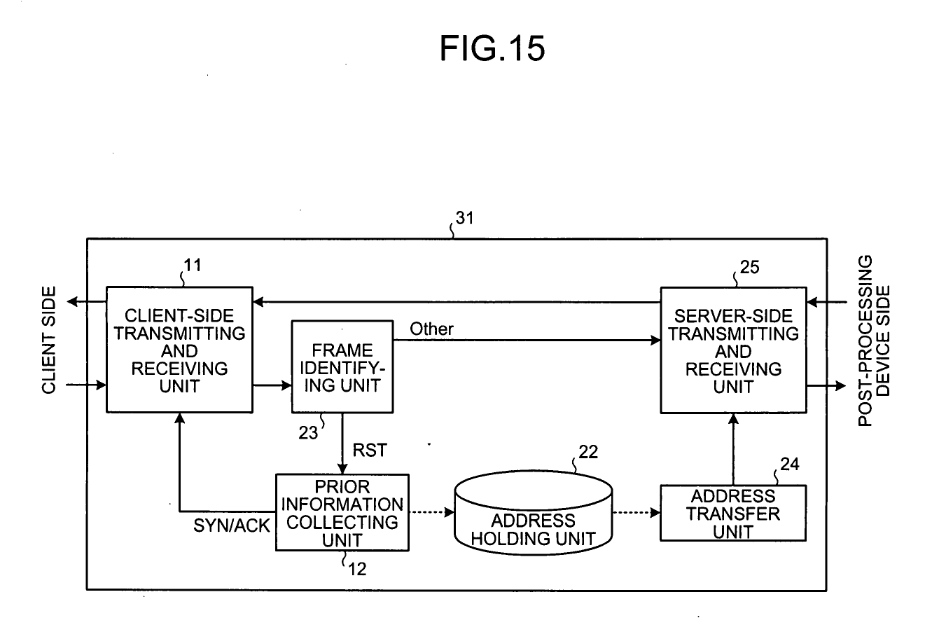

FIG. 15 is a block diagram of the pre-processing device. As shown in FIG. 15, the pre-processing device 31 includes a first client-side transmitting and receiving unit 11, the prior information collecting unit 12, a first address holding unit 22, a first frame identifying unit 23, an address transfer unit 24, and a first server-side transmitting and receiving unit 25. The first client-side transmitting and receiving unit 11 functions similarly to the client-side transmitting and receiving unit 11 according to the first embodiment, except that the prior information collecting unit 12 registers the entry of an address of the client and a valid attack flag value into the first address holding unit 22.

The first address holding unit 22 holds each address to be checked and a value “0” or “1” of a valid attack flag of the address. The first frame identifying unit 23 identifies header information of a frame received from the first client-side transmitting and receiving unit 11, and identifies whether the frame is a RST frame addressed to the own station (the pre-processing device 31) or other frame. When the received frame is the RST frame addressed to the own station, the first frame identifying unit 23 transmits this frame to the prior information collecting unit 12. When the received frame is other frame than the RST frame to the own station, the first frame identifying unit 23 transmits this frame to the first server-side transmitting and receiving unit 25.

The address transfer unit 24 periodically reads entries registered in the first address holding unit 22, for example, when the prior information collecting unit 12 completes the information collection, and transmits the list of entries to the first server-side transmitting and receiving unit 25. The first server-side transmitting and receiving unit 25 is connected to the post-processing device 32 via a network, and transmits and receives frames to and from the post-processing device 32. For example, the first server-side transmitting and receiving unit 25 receives a frame transmitted from-the post-processing device 32, and transmits this frame to the first client-side transmitting and receiving unit 11. The first server-side transmitting and receiving unit 25 receives a frame transmitted from the first frame identifying unit 23 or the address transfer unit 24, and transmits this frame to the post-processing device 32.

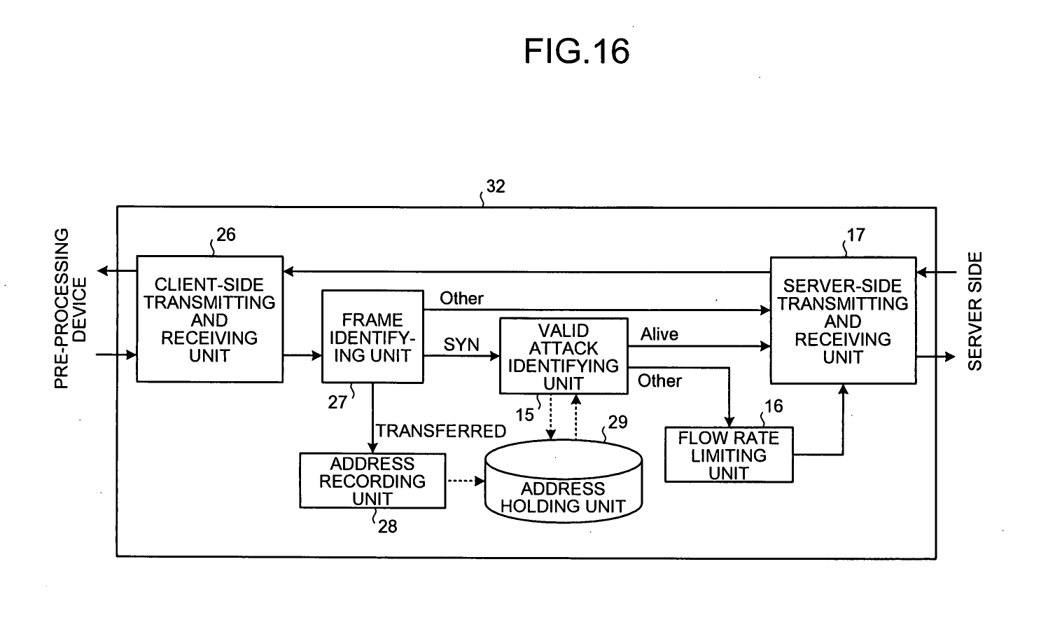

FIG. 16 is a block diagram of the post-processing device. As shown in FIG. 16, the post-processing device 32 includes a second client-side transmitting and receiving unit 26, a second frame identifying unit 27, an address recording unit 28, a second address holding unit 29, the valid attack identifying unit 15, the flow rate limiting unit 16, and a second server-side transmitting and receiving unit 17. The second client-side transmitting and receiving unit 26 is connected to the pre-processing device 31 via a network, and transmits and receives frames to and from the pre-processing device 31. For example, the second client-side transmitting and receiving unit 26 transmits a frame received from the pre-processing device 31 to the second frame identifying unit 27. The second client-side transmitting and receiving unit 26 transmits a frame received from the second server-side transmitting and receiving unit 17 to the pre-processing device 31.

The second frame identifying unit 27 identifies header information of a frame received from the pre-processing device 31, and identifies whether the received frame is a transfer information frame addressed to the own station (the post-processing device 32), a SYN frame to be relayed, or other frame. When the received frame is the transfer frame addressed to the own station, the second frame identifying unit 27 transmits this frame to the address recording unit 28. When the received frame is a SYN frame, the second frame identifying unit 27 transmits this frame to the valid attack identifying unit 15. When the received frame is other frame, the second frame identifying unit 27 transmits this frame to the second server-side transmitting and receiving unit 17.

The address recording unit 28 records the transfer information of the entry list received from the second frame identifying unit 27 in the second address holding unit 29. Accordingly, the entry list registered in the second address holding unit 29 is updated. The valid attack identifying unit 15 and the flow rate limiting unit 16 function similarly to those in the first embodiment, except the following. When the valid attack identifying unit 15 receives a frame from the second frame identifying unit 27, the valid attack identifying unit 15 reads a corresponding entry from the second address holding unit 29 based on the source address of the frame. The second server-side transmitting and receiving unit 17 is the same as the server-side transmitting and receiving unit 17 in the first embodiment.

The operation of the DoS attack preventing system is explained next. The addresses of the pre-processing device 31 and the post-processing device 32 are set to [10.0.0.2] and [20.0.0.1] respectively. It is assumed that the firewall 30 (see FIG. 14) blocks a TCP connection toward the inside of the subnet having the address [10.0.0.0/24]. The prior collection of the address by the pre-processing device 31 is performed similarly to that of case 1 and case 2 of the first embodiment, and therefore, redundant explanations are omitted.

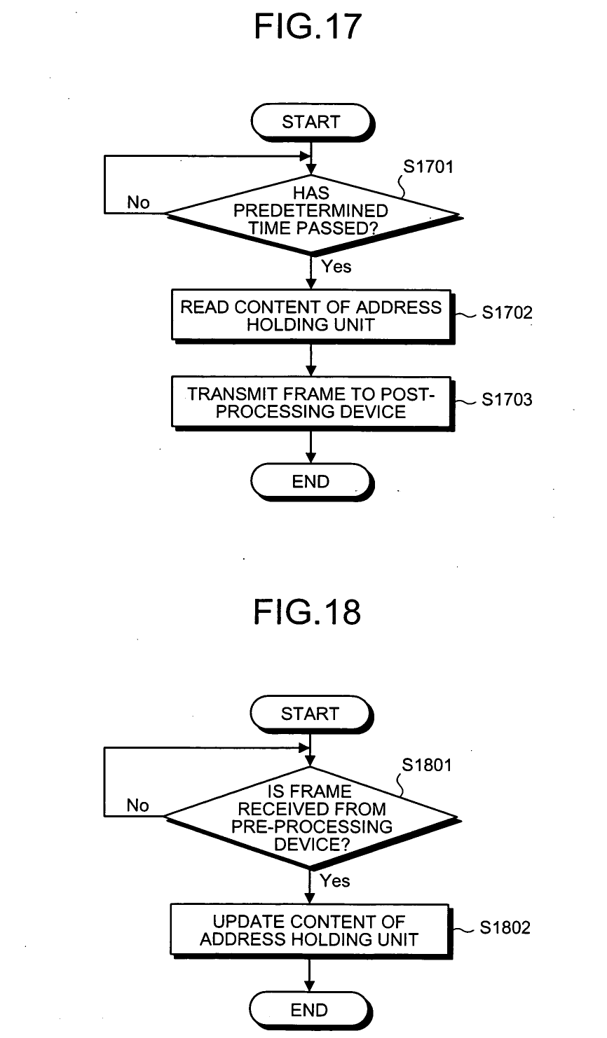

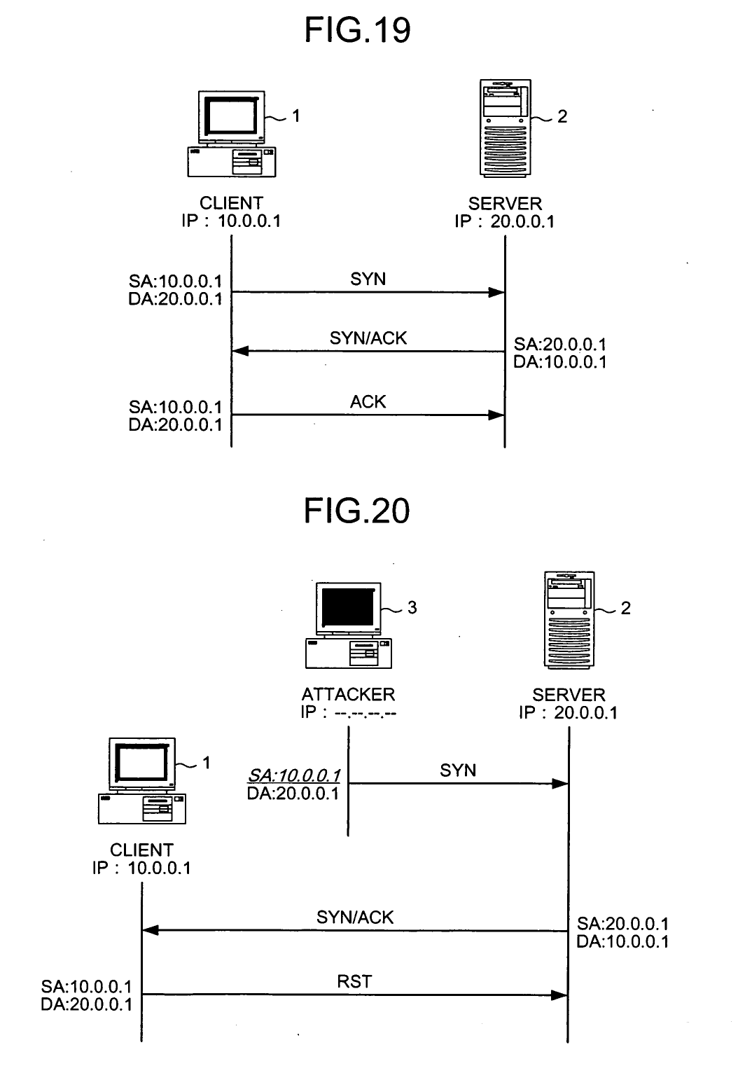

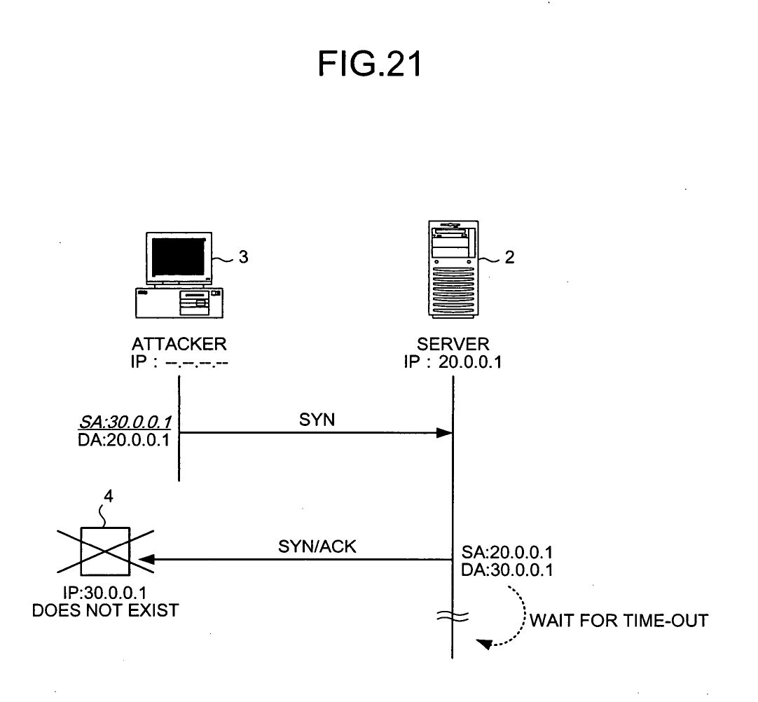

FIG. 17 is a flowchart of the operation of the pre-processing device. (70) As shown in FIG. 17, the pre-processing device 31 first determines whether a predetermined time has passed (step S1701). When the certain time has passed (“YES” at step S1701), the address transfer unit 24 reads the content registered in the first address holding unit 22 (step S1702). In other words, the address transfer unit 24 reads values of valid attack flags of all entries, that is, the addresses [10.0.0.0] to [10.0.0.255]. The address transfer unit 24 prepares a transfer information frame having [10.0.0.2] and [20.0.0.1] set to the source address and the destination address respectively, and transmits this frame to the first server-side transmitting and receiving unit 25. (71) The first server-side transmitting and receiving unit 25 transmits the frame received from the address transfer unit 24 to the post-processing device 32 (step S1703), thereby ending a series of processing.

FIG. 18 is a flowchart of the operation of the post-processing device. (72) As shown in FIG. 18, the post-processing device 32 determines whether the second client-side transmitting and receiving unit 26 has received a transferred information frame from the pre-processing device 31 (step S1801). When the frame is received (“YES” at step S1801), the second client-side transmitting and receiving unit 26 transmits this frame to the second frame identifying unit 27. (73) The second frame identifying unit 27 receives the frame from the pre-processing device 31 to the address [20.0.0.1] of the own station, and transmits this frame to the address recording unit 28. (74) The address recording unit 28 receives the frame from the second frame identifying unit 27, and updates the entries of the addresses [10.0.0.0] to [10.0.0.255] that are registered in the second address holding unit 29 (step S1802). The frame relay operation subsequently carried out by the post-processing device 32 is similar to that carried out in cases 3 to 5 in the first embodiment, and therefore, redundant explanations are omitted.

The present invention is not limited to the above embodiments, and various modifications can be applied. For example, the DoS-attack preventing device 10 and the post-processing device 32 can be incorporated in the server 2.

As described in the above embodiments, the flow rate of only a valid attack frame such as an illegitimate frame can be limited. Accordingly, even when the SYN flooding attack is carried out, services to legitimate clients are not interrupted.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A frame-transfer control device configured to transfer, to a network to which a server is connected, a frame transmitted from a client in an external network, the frame-transfer control device comprising:
a transmitting unit configured to periodically transmit a response request to the client, and to monitor a response to the response request from the client to grasp a responding state of the client;
an identifying unit configured to identify whether the frame is any one of a legitimate frame and an illegitimate frame based on the responding state; and
a limiting unit configured to transfer the legitimate frame to the server by priority, and to limit transfer of the illegitimate frame.

2. An attack preventing device configured to protect a network to which a server is connected, from an attack from an external network, the attack preventing device comprising:
a transmitting unit configured to transmit a first frame to at least one client connected to the external network, and to monitor a response to the first frame from the client with a second frame, to grasp a responding state of the client;
a first storing unit configured to store the responding state corresponding to an address of the client;
an detecting unit configured to detect an offensive frame with which the network is attacked from among at least one frame transmitted from the external network toward the server, based on information stored in the first storing unit; and
a limiting unit configured to limit a flow rate of the offensive frame by adjusting a transmission band to transfer the frame to the server.

3. The attack preventing device according to claim 2, further comprising a second storing unit configured to store an address of a client, wherein
the limiting unit is configured to transfer a frame transmitted from a client of which an address is stored in the second storing unit.

4. The attack preventing device according to claim 2, further comprising a searching unit configure to search an address of a client registered in a domain name system, and to provide the transmitting unit with the address of a registered client, wherein
the transmitting unit is configured to transmit the first frame only to the registered client.

5. The attack preventing device according to claim 2, further comprising a monitoring unit configured to monitor communication between the server and the client, and to cause the first storing unit to store an address of a client that has normally completed the communication.

6. The attack preventing device according to claim 2, further comprising a timing storing unit configured to store information on a monitoring time during which transmission of the first frame and the response with the second frame are monitored, and to inform the transmitting unit of a start time and an end time of the monitoring time, wherein
the transmitting unit is configured to monitor the transmission of the first frame and the response to the first frame based on the start time and the end time.

7. An attack preventing system configured to protect a network to which a server is connected, from an attack from an external network, the attack preventing system comprising:
a first processing device configured to be connected to the external network; and
a second processing device configured to be connected to the network, wherein
the first processing device includes
a transmitting unit configured to transmit a first frame to at least one client connected to the external network, and to monitor a response to the first frame from the client with a second frame, to grasp a responding state of the client;
a first storing unit configured to store the responding state corresponding to an address of the client; and
a transferring unit configured to transfer information stored in the first storing unit to the second processing device, and
the second processing device includes
a second storing unit configured to store transferred information;
a detecting unit configured to detect an offensive frame with which the network is attacked from among at least one frame transmitted from the external network toward the server, based on information stored in the second storing unit; and
a limiting unit configured to limit a flow rate of the offensive frame by adjusting a transmission band to transfer the frame to the server.

8. The attack preventing device according to claim 7, wherein the first processing device further includes a second storing unit configured to store an address of a client, and
the limiting unit is configured to transfer a frame transmitted from a client of which an address is stored in the second storing unit.

9. The attack preventing device according to claim 7, wherein the first processing device further includes a searching unit configure to search an address of a client registered in a domain name system, and to provide the transmitting unit with the address of a registered client, and
the transmitting unit is configured to transmit the first frame only to the registered client.

10. The attack preventing device according to claim 7, wherein the second processing device further includes a monitoring unit configured to monitor communication between the server and the client, and to cause the second storing unit to store an address of a client that has normally completed the communication.

11. The attack preventing device according to claim 7, wherein the first processing device further includes a timing storing unit configured to store information on a monitoring time during which transmission of the first frame and the response with the second frame are monitored, and to inform the transmitting unit of a start time and an end time of the monitoring time, wherein
the transmitting unit is configured to monitor the transmission of the first frame and the response to the first frame based on the start time and the end time.
